(19) United States
(12) Patent Application Publication
(10) Pub. No.: US 2021/0332600 A1
(43) Pub. Date: Oct. 28, 2021

(54) ADHESIVE APPLICATOR SYSTEM AND OPERATING METHOD

(71) Applicant: FASTBRICK IP PTY LTD., High Wycombe, Western Australia (AU)

(72) Inventors: Harald APFELTHALER, Kalamunda, Western Australia (AU); David Meng-san WONG, West Perth, Western Australia (AU); Mark Joseph PIVAC, Lesmurdie, Western Australia (AU)

(21) Appl. No.: 17/273,471

(22) PCT Filed: Sep. 4, 2019
(86) PCT No.: PCT/AU2019/000102

§ 371 Date: Mar. 4, 2021

(30) Foreign Application Priority Data
Sep. 4, 2018 (AU) 2018903276

(51) Int. Cl. E04G 21/22; F04B 49/08; B05B 13/04; B25J 15/00; B25J 15/02

(52) U.S. Cl. CPC E04G 21/22; F04B 49/08; F04B 49/065; B25J 15/008; B25J 15/0253; B05B 13/041

(57) ABSTRACT

The present disclosure provides an adhesive application system for an automated brick laying machine, the adhesive application system comprising an adhesive reservoir, an adhesive supply line extending from the reservoir to one or more nozzles configured to dispense adhesive, a first pump (a primary pump) positioned near to the reservoir, at least one further pump (secondary pump) positioned near to the or each of the nozzles, a supply line load cell positioned near to the or each secondary pump, and a control system, wherein in use, the control system controls operation of the primary pump in response to a supply pressure sensed at the supply line load cell. An adhesive applicator and method for controlling an adhesive application system are also disclosed.

### PRIORITY DOCUMENTS

The present application claims priority from Australian Provisional Application No. 2018903276 titled “ADHESIVE APPLICATOR SYSTEM AND OPERATING METHOD” as filed on 4 Sep. 2018, the content of which is hereby incorporated by reference in its entirety.

### INCORPORATION BY REFERENCE

The following publication is referred to in the present application and its contents are hereby incorporated by reference in their entirety:

International Patent Application No. PCT/AU2017/050728 (WO/2018/009978) titled “ADHESIVE APPLICATOR AND OBJECT PLACING HEAD INCORPORATING THE SAME” in the name of Fastbrick IP Pty Ltd.

### TECHNICAL FIELD

The present disclosure relates to an automated brick laying machine, an adhesive application system for the machine, and an adhesive applicator assembly.

### BACKGROUND

International Patent Application No. PCT/AU2017/050728 (WO/2018/009978) discloses a brick laying and adhesive applying head, or lay head, which is fitted to an articulated telescopingly extendable boom mounted on a truck, forming an automated brick laying machine. The lay head applies adhesive to the brick, and comprises a robot which lays the brick.

The truck supports the brick laying machine, which is mounted on a frame on the chassis of the truck. The frame supports an adhesive container and an adhesive pump. The adhesive pump supplies pressurised adhesive to fluid conveying apparatus in the form of a hose which runs out along the boom to the lay head.

A flipper assembly comprises jaws to grip a brick and translate and rotate the brick to move it past adhesive application nozzles, and then present the brick for transfer to the robot laying arm.

The adhesive application nozzles are extended out over the brick. The adhesive nozzles direct adhesive downwards so that gravity assists in applying the adhesive to the brick.

The brick laying machine is intended to handle a wider brick, for external wall applications, and a narrow brick for internal wall applications. In order to accommodate both the wide and narrow bricks, the adhesive applicator assembly comprises a manifold that supports two valves. Each valve is connected to the pressurised adhesive supply provided by the adhesive pump mounted to the frame of the truck. The first valve is connected to three central adhesive nozzles and the second valve is connected to two outer adhesive nozzles. The inner nozzles are provided to allow adhesive to be applied to the top face of a narrow or internal brick, while the outer nozzles allow adhesive to be applied to the outer edges of the top face of a wide or external brick. Fine control of adhesive supply at the nozzles is difficult to effect with the arrangement of PCT/AU2017/050728, which leads to unacceptable adhesive coverage on the brick, and an unacceptable joint between bricks. It was also difficult pumping adhesive out along the boom (up to 30 m long) from the adhesive supply located on the base of the truck.

It is against this background that the present invention has been developed.

Other objects and advantages of the present invention will become apparent from the following description, taken in connection with the accompanying drawings, wherein, by way of illustration and example, an embodiment of the present invention is disclosed.

### SUMMARY

According to a first aspect, there is provided an adhesive applicator assembly for an automated brick laying machine, the adhesive applicator assembly comprising a base, at least one nozzle carriage assembly, the or each nozzle carriage assembly comprising a carriage, and at least one adhesive outlet nozzle depending from the carriage, for dispensing adhesive received from a supply of adhesive via an adhesive supply line, and at least a transverse drive means for driving the or each nozzle carriage assembly transversely relative to the base.

A position of the or each nozzle of this adhesive applicator assembly can be transversely positioned as required, and moved between various positions. This nozzle arrangement is able to dispense adhesive onto bricks of varying widths.

In one form, the adhesive applicator assembly comprises at least two of the nozzle carriage assemblies.

A transverse spacing between the nozzles of this adhesive applicator assembly can be set as required, to accommodate bricks of varying widths.

In one form, each of the nozzle carriage assemblies is movable independently of the others.

In one form, the base comprises a track, and the or each nozzle carriage assembly is disposed to run along the track.

In one form, a drive means drives the or each nozzle carriage assembly along the track.

In one form, this drive means comprises a motor driven leadscrew. In an alternative, this drive means might comprise a drive belt or a gear rack and pinion arrangement.

In one form, the or each nozzle carriage assembly comprises at least one adhesive pump delivering the adhesive to a respective nozzle. By providing a pump close to the nozzles, the required line pressure can be maintained or varied as needed in order to dispense at a desired rate and volume.

In one form, in an alternative, the base comprises an adhesive pump delivering adhesive to each nozzle.

In one form, a position of each nozzle can be vertically adjusted with respect to the base.

In one form, this vertical adjustment is manually effected. In an alternative, it is automated.

In one form, a position of each nozzle can be vertically adjusted with respect to the carriage from which it depends.

In one form, this vertical adjustment is manually effected. In an alternative, it is automated.

According to a further aspect, there is provided an adhesive application system for an automated brick laying machine, the adhesive applicator system comprising the above described adhesive applicator assembly, an adhesive reservoir, the adhesive supply line extending from the reservoir to the or each nozzle, and at least one pump for delivering adhesive to the adhesive applicator assembly.

In one form, this adhesive application system further comprises a first pump (a primary pump) positioned near to the reservoir, at least one further pump (secondary pump) positioned near to the or each of the nozzles, a supply line load cell positioned near to the at least one further pump, and a control system, wherein in use, the control system controls operation of the first pump in response to a supply pressure sensed at the supply line load cell.

According to a further aspect, there is provided an adhesive application system for an automated brick laying machine, the adhesive application system comprising an adhesive reservoir, an adhesive supply line extending from the reservoir to one or more nozzles configured to dispense adhesive, a first pump (a primary pump) positioned near to the reservoir, at least one further pump (secondary pump) positioned near to the or each of the nozzles, a supply line load cell positioned near to the further pump, and a control system, wherein in use, the control system controls operation of the first pump in response to a supply pressure sensed at the supply line load cell.

In one form, if a pressure sensed by the supply line load cell falls below a threshold pressure, the primary pump is controlled to return the sensed pressure to at least the threshold pressure.

In one form, the control system controls the secondary pumps based on an adhesive dispense recipe which comprises a set of variables used to control the dispensing of the adhesive, and a dispense signature which is determined by brick parameters and dispense recipe variables.

In one form, the adhesive application system comprises the above described adhesive applicator assembly.

In one form, the base of the adhesive applicator assembly comprises the supply line load cell.

According to a further aspect there is provided a control system for the above described adhesive application system.

According to a further aspect there is provided a method for controlling an adhesive application system, the adhesive application system comprising an adhesive reservoir, an adhesive supply line extending from the reservoir to one or more nozzles configured to dispense adhesive, a first pump positioned near to the reservoir, at least one further pump positioned near to the nozzles, a supply line load cell positioned near to the further pump, and a control system, the method comprising the steps of monitoring the supply line load cell and controlling the operation of the first pump in response to this.

In one form, if a pressure sensed by the supply line load cell falls below a threshold pressure, the primary pump is controlled to return the sensed pressure to at least the threshold pressure.

### BRIEF DESCRIPTION OF DRAWINGS

Embodiments of the present invention will be discussed with reference to the accompanying drawings wherein:

FIG. 1 is a schematic illustration of an automated brick laying machine comprising a boom, which is in its retracted position;

FIG. 2 is a schematic illustration of the automated brick laying machine with the boom extended;

FIG. 3 is a schematic illustration of a lay head assembly from the automated brick laying machine of FIG. 1;

FIG. 4 is a view of the lay head assembly positioned to permit visibility of an adhesive applicator assembly;

FIG. 5 illustrates the adhesive applicator assembly exploded from a remainder of the lay head assembly;

FIG. 6 is an isometric view of an adhesive applicator assembly from the lay head assembly of FIG. 5;

FIG. 7 is an end view of the adhesive applicator assembly of FIG. 6;

FIG. 8 is a side view of the adhesive applicator assembly of FIG. 6;

FIG. 9 is a plan view of the adhesive applicator assembly of FIG. 6;

FIG. 10 is an exploded view of the adhesive applicator assembly of FIG. 6;

FIG. 11 is an exploded view of a drive assembly from the adhesive applicator assembly of FIG. 6;

FIG. 12 is a schematic of an adhesive application system which incorporates the adhesive applicator assembly;

FIG. 13 is a schematic view of an adhesive supply line for use in an adhesive application system according to an embodiment;

FIG. 14 is an exploded view of a supply line load cell from the adhesive application system of FIG. 12;

FIG. 15 is a flow diagram illustrating a starting sequence for the adhesive application system;

FIG. 16 is a flow diagram illustrating running sequence for the adhesive application system;

FIG. 17 is a flow diagram illustrating a stopping sequence for the adhesive application system;

FIG. 18 illustrates a ‘dispense signature’, comprising two beads of adhesive applied to a brick;

FIG. 19 illustrates an alternative nozzle for the adhesive applicator assembly; and

FIG. 20 is a cross-sectional view of the nozzle of FIG. 19.

In the following description, like reference characters designate like or corresponding parts throughout the figures.

### DESCRIPTION OF EMBODIMENTS

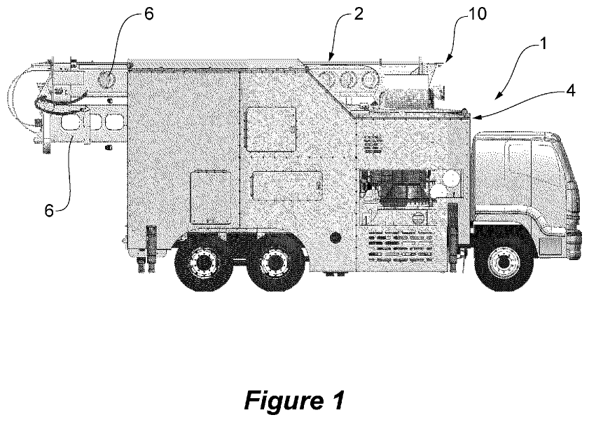

Referring now to FIG. 1, where there is illustrated an automated brick laying machine 1. Details of the machine 1 which are similar to those of the machine disclosed in WO/2018/009978 will only be discussed briefly here.

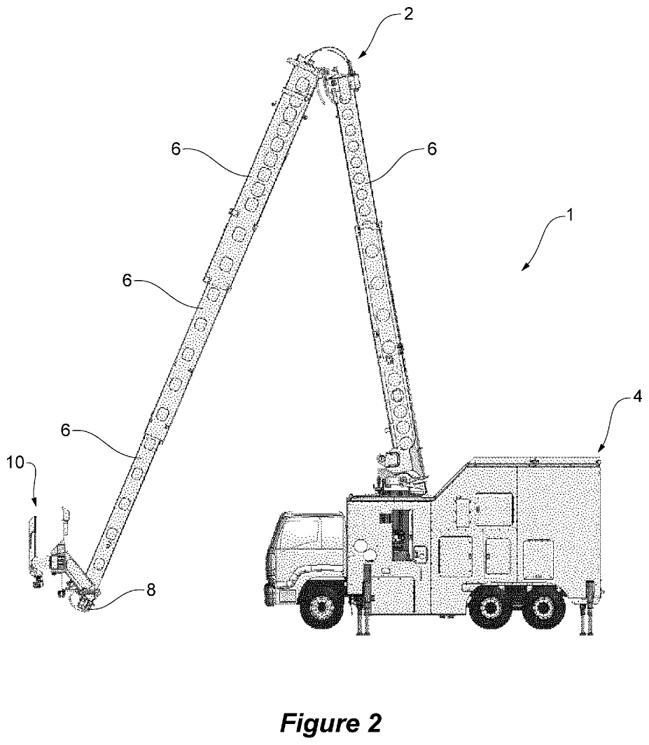

The machine 1 comprises an articulated telescopingly extendable boom 2 mounted on a truck 4, and an adhesive applying and bricklaying head (a lay head) assembly at the end of the boom 2. In FIG. 1 the boom 2 is shown retracted for transport, and in FIG. 2 the boom 2 is shown extended, and ready for use to lay bricks.

The boom 2 is comprised of a series of sticks 6, each of which is provided with an internal shuttle. These shuttles are not visible in FIGS. 1 and 2 on account of being internal to the sticks 6. Each of the shuttles is fitted with a gripper for holding a brick. The shuttles move a brick from the truck 4, along the boom 2 and pass it from one shuttle to the next, and then onto a flipper assembly 8.

The flipper assembly 8 is located at the distal end of the most distal stick 6 of the boom 2. The flipper assembly 8 comprises a gripper with jaws to grip a brick and then translate and rotate the brick to move it past an adhesive applicator assembly 100, and then present the brick for transfer to a laying arm 12 which depends from the lay head 10.

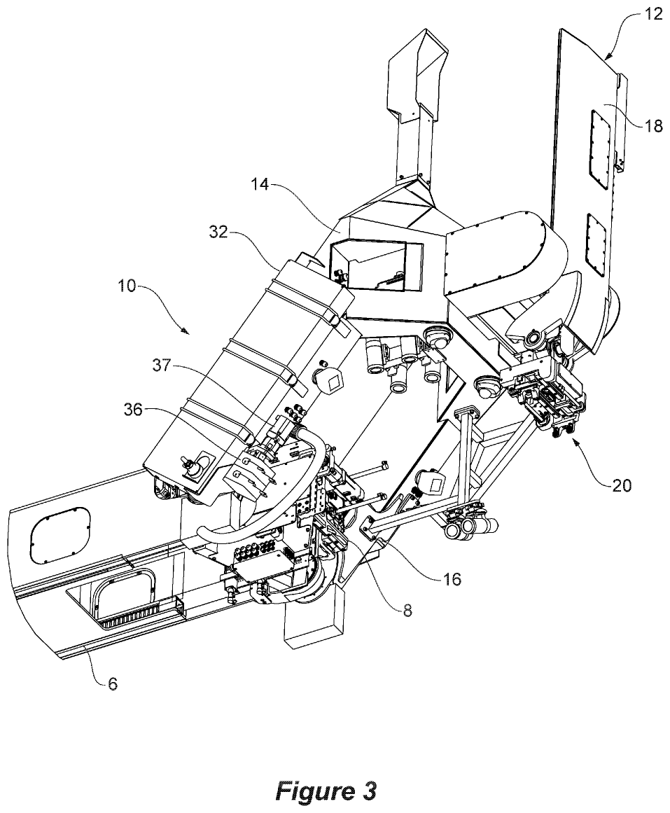

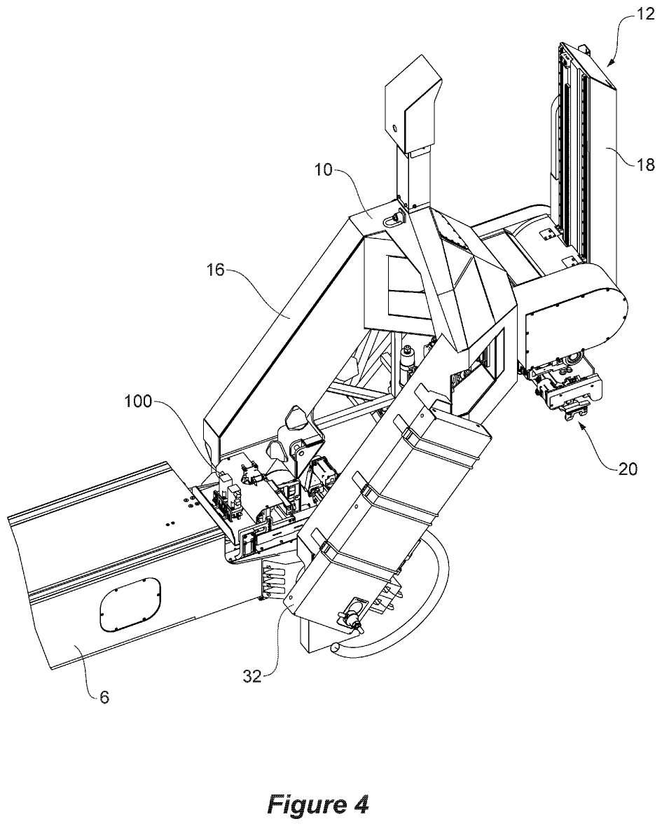

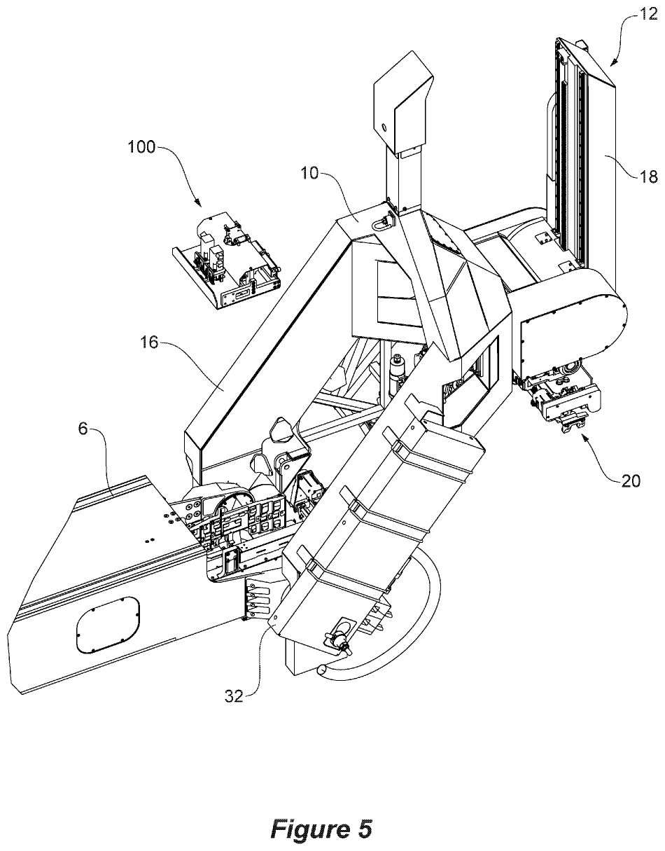

Referring now to FIGS. 3 and 4, the lay head assembly 10 comprises a clevis shaped body 14 comprising a pair of arms 16 via which the clevis 14 is pivotally mounted for controlled rotation relative to the remote end of the boom 2.

The laying arm 12 comprises a robotic arm 18 which is pivotably mounted to the clevis 14 via a slewing drive, and to the end of which is fitted a further end effector 20 in the form of a gripper comprising a pair of jaws, for handling the bricks and laying them.

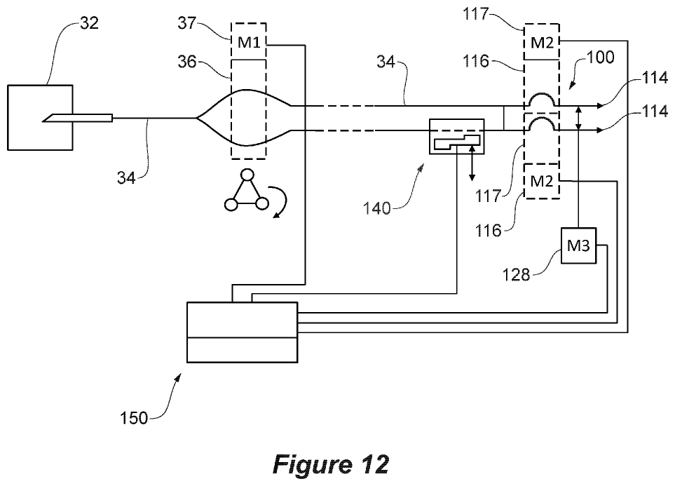

The lay head assembly 10 further comprises components of an adhesive application system 30, which is illustrated schematically at FIG. 12. The adhesive application system 30 comprises a replaceable adhesive cartridge 32, an adhesive supply line 34 extending from the cartridge 32 to the adhesive applicator assembly 100, and at least one adhesive pump 36 driven by a motor 37 for delivering adhesive to the adhesive applicator assembly 100 via the adhesive supply line 34.

The adhesive cartridge 32 contains a reservoir of between 15 to 20 litres of adhesive, which should be sufficient for the construction of an average sized brick house. It is to be appreciated however that the capacity could be higher depending on the size of the build and in some examples could be 15 to 40 litres. The adhesive cartridge mounts with respect to one of the arms 16 of the clevis 14 of the layhead. In this way, the adhesive supply is located on the layhead in proximity to the adhesive applicator assembly which dispenses adhesive onto the bricks before they are laid.

Examples of a suitable adhesive include Huntsman Suprasec® 7273, and Selleys Aquadhere Durabond®. These adhesives are moisture curing, high strength, polyurethane construction adhesives and it will be appreciated that other similar adhesives may also be used and these examples are not intended to be limiting.

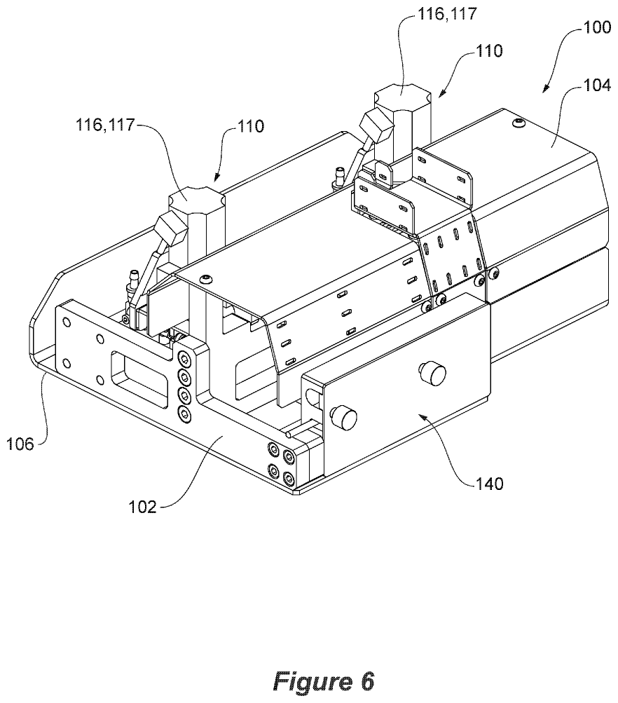

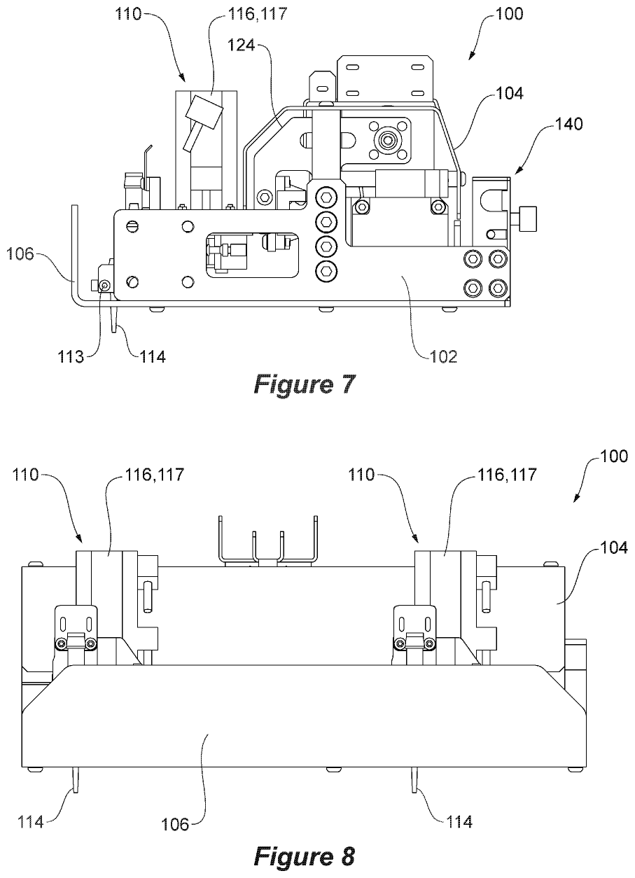

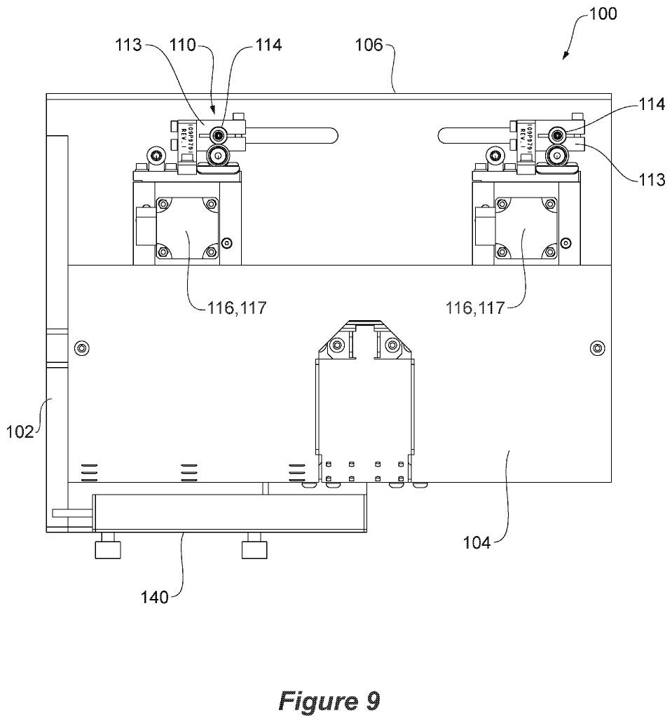

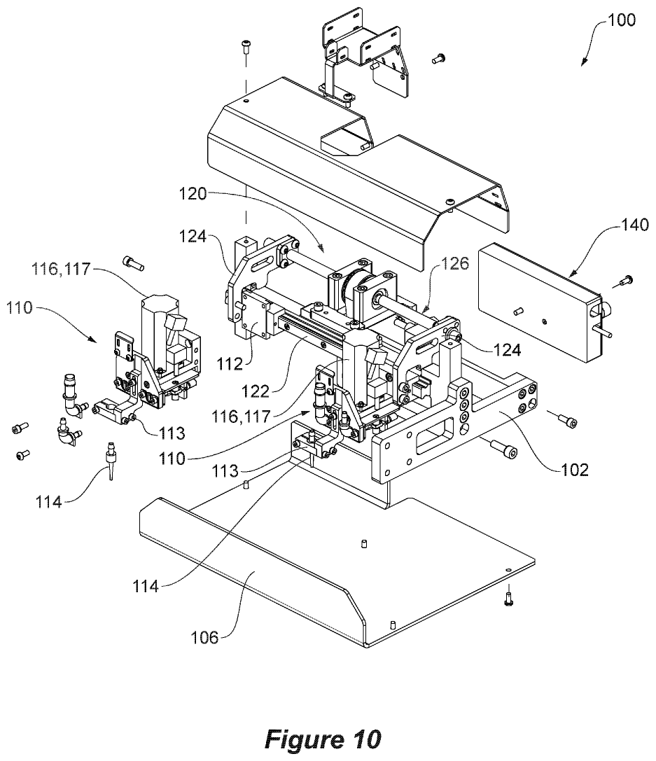

Referring now to FIGS. 6 through 11, the adhesive applicator assembly 100 comprises a base 102, and, in this embodiment, a pair of nozzle carriage assemblies 110, each of which comprises a carriage 112, and at least one adhesive outlet nozzle 114 depending from the carriage 112, for dispensing adhesive received from the supply line 34, and a transverse drive means 120 for driving the or each nozzle carriage assembly 110 transversely relative to the base 102.

Each nozzle carriage assembly 110 comprises a further adhesive pump 116 driven by a motor 117 for delivering the adhesive to its respective nozzle 114. Given that these further adhesive pumps 116 are downstream of the aforementioned adhesive pump 36, these will hereinafter be referred to as ‘secondary pumps’ 116, whereas the aforementioned adhesive pump 36 will be referred to as the ‘primary pump’ 36.

The primary pump 36 transports the adhesive from the adhesive cartridge 32 to the secondary pumps 116 and maintains the fluid (adhesive) pressure supplied to the secondary pumps 116, ensuring that their performance is not undermined by inconsistent supply.

These secondary pumps 116 control the adhesive flow to each nozzle 114 and can be operated independently of each other. They also can be driven in reverse to control suck-back.

The adhesive application system 30 further comprises a supply line load cell 140, which will sense fluid pressure in the supply line 34 at a position just before the secondary pumps 116. Accordingly, this supply line load cell 140 is mounted to the base 102 of the adhesive applicator assembly 100.

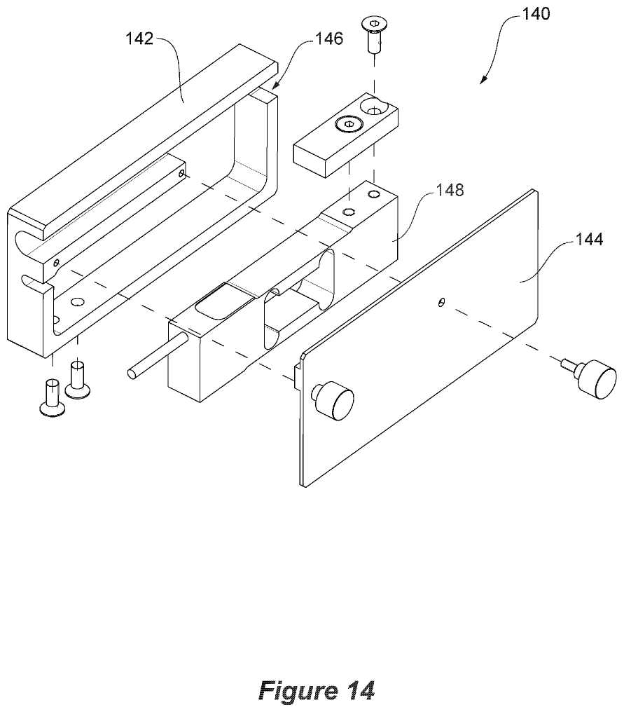

With reference to FIG. 14, it can be seen that the supply line load cell 140 comprises a housing 142 with a cover 144, the housing 142 comprising a channel 146 through which a portion of the supply line 34 will pass. A strain gauge 148 which bears against the tubing of the supply line 34 at one end is also contained in the housing 142. The load cell 140 further comprises a DC15V Wheatstone bridge circuit connected to a soft-PLC. In use, the output from the supply line load cell 140 will be used to control the primary pump 36, to ensure consistent adhesive pressure at the secondary pumps 116. The use of a load cell enables the adhesive line pressure to be monitored externally without any direct contact with the adhesive itself which is advantageous.

An adhesive heating cartridge may also be integrated into the load cell block in order to heat the adhesive as it passes through the load cell. An electric heat cartridge could be used with thermosensing to allow the heating to be controlled by the controller as required in response to variables such as ambient temperature. As an alternative to the heat cartridge, an electrical heating cable could be housed in a conduit or sheath around part of the supply line in proximity to the secondary pumps and outlet nozzles.

The adhesive is dispensed onto the bricks via the nozzles 114. The position of the nozzle carriage assemblies 110, and thus the nozzles 114 in turn, can be positioned using the transverse drive means 120 to adjust for the width of each brick, and to change the adhesive dispense pattern.

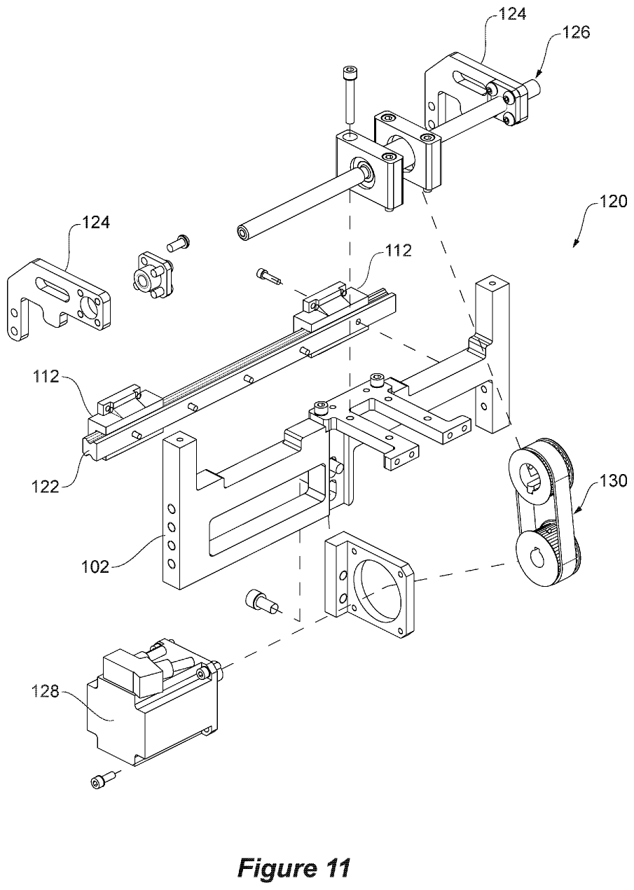

With reference to FIG. 11, it can be seen that in the illustrated embodiment, these transverse drive means 120 for the two nozzles 114 comprises a guide track 122 along which the carriages 112 slide. A drive arm 124 extends from a leadscrew 126 to each of the carriages 112. This leadscrew 126 is driven by a motor 128 via a belt drive 130. An absolute encoder is direct coupled to the motor shaft, providing position feedback.

A nozzle holder 113 holds each nozzle 114. Where each nozzle holder 113 is bolted to its respective carriage 112, the nozzle holder 113 is slotted to permit vertical adjustment of the nozzle 114 position.

The adhesive applicator assembly 100 further comprises a top cover 104 and a bottom cover 106 for shielding the transverse drive means 120.

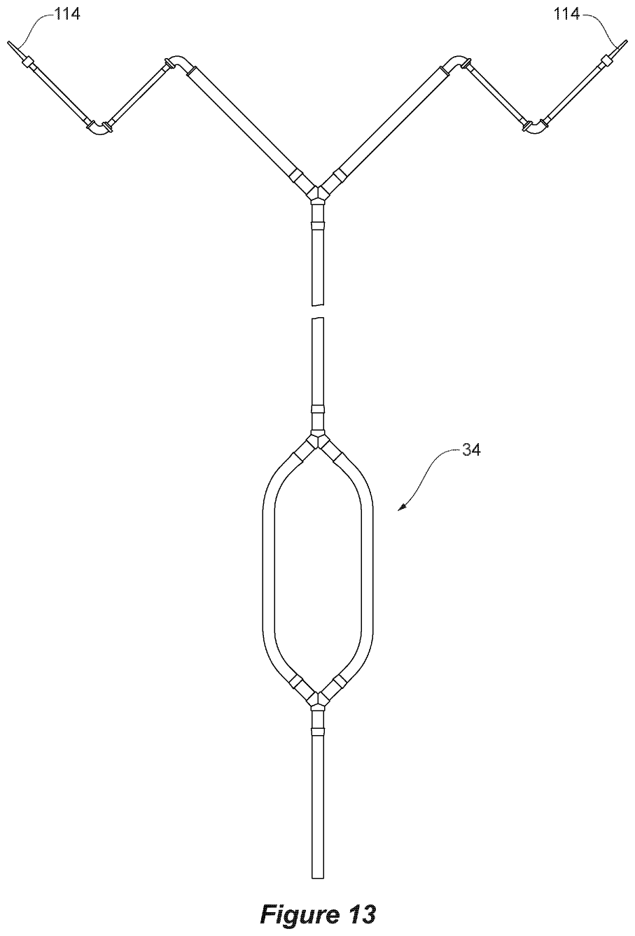

With reference to FIG. 13, in the illustrated embodiment, the supply line 34 comprises flexible silicone tubing, which branches into two at a point corresponding to the primary pump 36, merges at a junction after the primary pump 36, and continues as a single line to the adhesive applicator assembly 100, before branching into two nozzle supply lines extending to and terminating at the two nozzles 114. Connector fittings are employed as required to form these branches and junction.

In an alternative embodiment and as depicted in FIG. 12, instead of merging at a junction after the primary pump 36, the supply line may continue as two separate lines to respective secondary pumps and nozzles. In this example, one of the two lines will run through the load cell in order to obtain the required pressure feedback for the primary pump. In yet a further embodiment of the supply line, the line may merge at a junction after the primary pump, before branching out into two nozzle supply lines before the load cell. In the example where the supply line continues as a dual lines after the primary pump, this may allow for an increased flow rate but then the lines would need to be balanced by a balancing bridge which balances the pressure in the respective lines to prevent the adhesive in one line being ahead of the other.

Each of the primary pump 34 and the secondary pumps 116 is a peristaltic pump. Internally, these pumps comprise a rotor with a number of “rollers”, “shoes”, “wipers”, or “lobes”. As the rotor turns, the part of the tubing of the supply line 34 under compression is pinched closed (or “occludes”) thus forcing the fluid to be pumped to move through the tube of the adhesive supply line 34. A benefit of peristatic pumps is that the adhesive remains in the line and does not flow through the pump which would may cause the pump to seize up and would be difficult to clean/purge. If increased supply pressure was required, jet pumps or gear pumps could be used however they would need to be self-flushing (i.e. purging) by allowing a solvent to circulate inside the pumps to prevent damage.

Operation of the adhesive application system 30 and its adhesive applicator assembly 100 is controlled by a control system 150 represented schematically in FIG. 12.

Accordingly, the control system 150 may include a variety of components. Exemplary components may include those that monitor electric signals, switch electric signals, perform sensing functions, and govern activation and deactivation of components.

Further, the control system may comprise a processor, a memory, storage, and a user interface. The control system may be controlled by software. The control system may provide users with precise control, data logging, diagnostic information and performance information for governing the adhesive application system.

The control system will control functions including, but not necessarily limited to: the position of the nozzles 114, the rate and direction of movement of the nozzles 114, when adhesive is dispensed from the nozzles 114, the rate at which adhesive is dispensed from the nozzles 114, the operation of the primary pump 36, and the operation of the secondary pumps 116.

The adhesive application system can operate in both an automatic control and a remote control mode. The basic function of the adhesive application system 30 is to dispense adhesive onto a brick face surface held in position by the flipper 8, with variables controlled by a ‘dispense recipe’. The flipper works in conjunction with the adhesive applicator assembly 100 to move the brick under the nozzles 114 such that the adhesive is applied onto the brick.

This control system 150 will store a number of dispense recipes. Because the properties of the adhesive vary depending on factors including the ambient temperature and humidity, these recipes will vary depending on these factors. Accordingly a different recipe will be required in the morning to the one used in the afternoon. Different recipes will require different run times and operating speeds for the primary and secondary pumps 36 and 116, and different nozzle 114 heights relative to the brick. Because some tuning of recipes will likely be required, calibration runs are performed prior to a build, and these recipes can be edited, saved and selected as required.

Under normal operating conditions the adhesive application system will operate in automatic control mode. In the event of a malfunction, operator intervention may be required.

Under normal automatic control, the adhesive application system shall operate utilising the following sequence functions:

Start sequence (Un-Pack);

Running sequence (Operating); and

Stop sequence (Pack-up).

The cartridge 32 requires onsite installation and priming during the site preparation sequence of the machine 1. Similarly, the cartridge 32 must always be removed and replaced before depletion or during the machine 1 pack up.

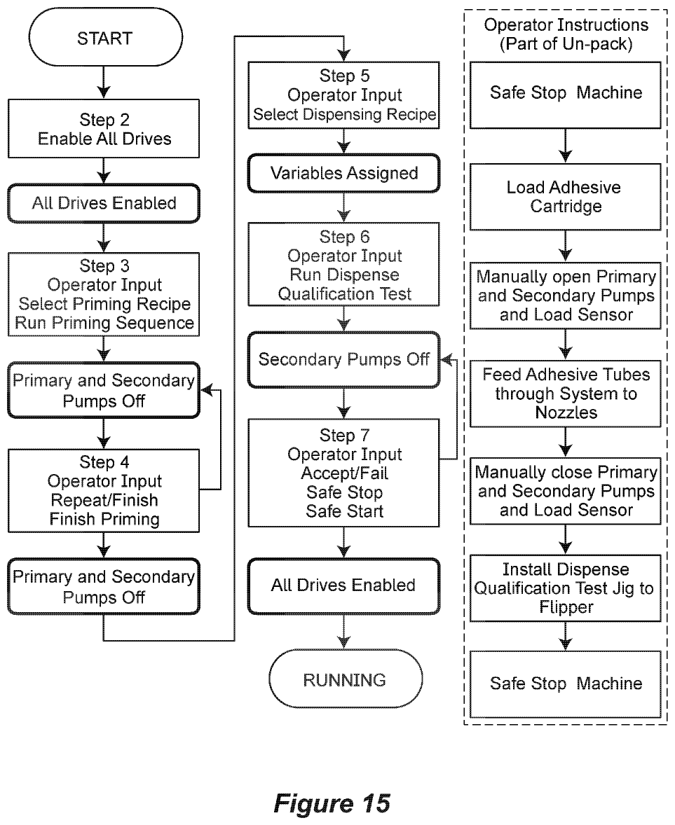

Referring now to FIG. 15, the start sequence controls the start-up procedure for the adhesive application system 30. Before activating the start sequence the operator must have loaded the adhesive cartridge 32 and the tubes of the supply line 34. This is done during the machine un-pack sequence, or boom start-up sequence.

To load the cartridge 32, the operator must perform a safety stop on the machine 1 to make it safe to approach. The operator must then manually attach the adhesive cartridge 32 and feed the lines through the system to the nozzles 114 (Step 1). The nozzles 114 should be at outermost spacing position upon installation, allowing the operator to connect the tubes without needing to account for nozzle 114 movements, as this is the maximum spacing. The height position of the nozzles 114 will need to be manually adjusted to the same height by the operator, as determined by the dispense recipe.

Once the cartridge 32 has been loaded, and the machine 1 is started, the machine 1 will enable all drives in the adhesive application system 30 (Step 2). Then the adhesive application system 30 requires the operator input to select and run a priming recipe. To prime the supply line tubes 34 with adhesive the primary pump 36 and both secondary pumps 116 are run for a set time at a set speed determined by the recipe (Step 3), repeated by operator input until adhesive begins to dispense from each nozzle 114 into a waiting container, which is when the operator provides input to finish the priming (Step 4).

To transition to the running sequence, first a dispense recipe must be chosen by the operator (Step 5) then run a dispense qualification test to check the dispense signature (Step 6). This test will dispense the recipe volume and pattern onto a disposable surface held by a jig to the flipper 8. This will allow the operator to check the system is running correctly. The operator then checks the test passes the requirements and confirms it is okay, then safety stops the machine 1 to remove the qualification test jig and safety starts the machine 1 to transition to running sequence (Step 7).

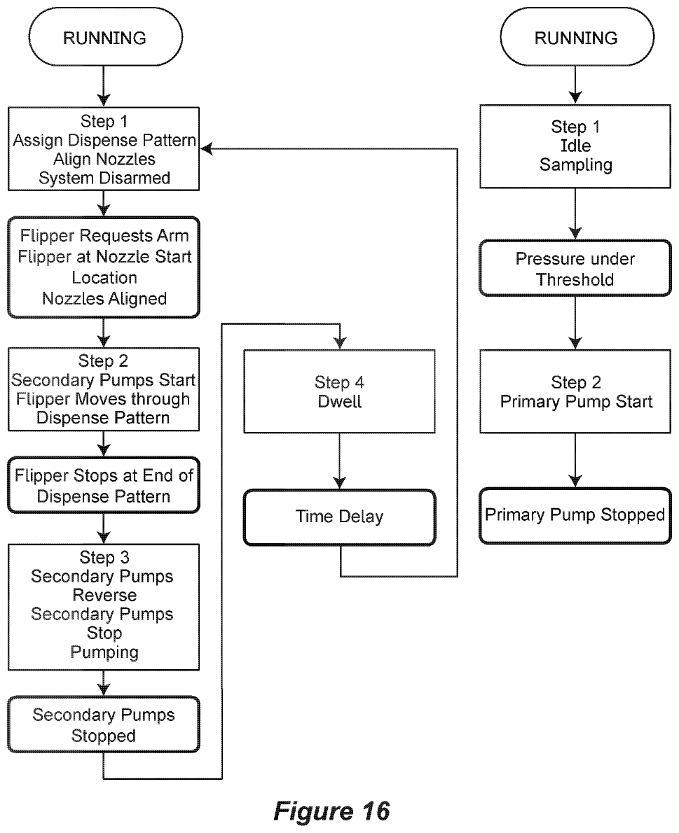

Referring now to FIG. 16, the running sequence controls the dispense operation for the adhesive application system 30. The adhesive application system 30 will remain in the running state unless requested to stop.

Step 1 is the idle state of the flipper 8. In this state the adhesive application system 30 will look up the properties of the next brick in the sequence, account for its width (is it an external or internal wall brick?) and length (has the brick been cut?), define a dispense pattern and adjust the nozzles 114 to the required positions. This is the only state which allows for pausing and stopping. Once the flipper 8 requests the adhesive system 30 to arm, and the flipper 8 is within the dispense pattern region, and the nozzles 114 have been moved to the start point of the dispense pattern, the adhesive application system 30 will transition to Step 2.

Step 2 is the state responsible for applying the adhesive to the brick. In this state, the secondary pumps 116 are enabled, the nozzle 114 spacing is controlled to follow the dispense pattern and each secondary pump 116 can be toggled to account for any gaps required in the dispense pattern. The system 30 stays in this state until the flipper 8 stops at the end location of the dispense pattern or either leaves the region, or the flipper 8 requests a disarm, in which case it moves onto the next step.

The disarming and shutoff procedure is separated into 2 steps. The first of these states shuts off the secondary pump 116 (Step 3). The transition out of Step 4 is determined by a time delay as there is no feedback to their state. The specific time delays for these waits will be determined by the dispense recipe variables.

The running sequence of the primary pump 36 and load cell 140 is separate from the secondary pumps 116 and flipper 8.

Step 1 is the idle state of the primary pump 36 with the load cell 140 sampling the supply line 34 tube pressure until the pressure falls below a threshold value determined by the recipe, then will transition to Step 2.

Step 2 is the state responsible for pressurising the supply line 34 tubes via the primary pump 36. In this state the primary pump 36 is enabled and runs a set number of rotations followed by a time delay, then will transition back to Step 1.

During running sequence, the adhesive application system 30 will follow a dispense recipe which will define the exact application signature and will be dependent on several external factors including temperature, humidity and operator input. Each recipe will contain a set of variables used to control the dispensing of the adhesive.

In Table 1 below, example recipe variables are provided.

TABLE 1
Recipe editor variables

| Variable | Description | Adjustment | Example | |
|---|---|---|---|---|
| Recipe No. | Number of the recipe | Digital per GUI editor | 1 | |
| Default | Shows if the recipe is a | Digital per GUI editor | Y | |
| | default or custom | | | |
| Temp. Minimum | Minimum temperature to | Digital per GUI editor | 11° | C. |
| | use the recipe at | | | |
| Temp. Maximum | Maximum temperature to | Digital per GUI editor | 20° | C. |
| | use the recipe at | | | |
| Dwell Time | Time adhesive is left on | Digital per GUI editor | 15 | s |
| | brick before flipping | | | |
| Bead Repetition | Number of bead lines | Digital per GUI editor | 2 | beads |
| | dispensed from each | | | |
| | nozzle | | | |
| Bead Distance | Distance between each | Digital per GUI editor | 5 | mm |
| | bead line | | | |
| Bead to Edge | Bead distance from edge | Digital per GUI editor | 10 | mm |
| | of the brick | | | |
| Bead Start Distance | Distance from the end of | Digital per GUI editor | 10 | mm |
| | brick to the start of the | | | |
| | bead | | | |
| Bead End Distance | Distance from far end of | Digital per GUI editor | 10 | mm |
| | the brick to the end of the | | | |
| | bead | | | |
| Zig-Zag Amplitude | Distance the nozzles | Digital per GUI editor | 0 | mm |
| | oscillate side to side as | | | |
| | each bead is dispensed. | | | |
| Translation Speed | Speed of the brick | Digital per GUI editor | 100 | mm/s |
| | travelling past the nozzles | | | |
| Nozzle Aperture Speed | Speed at which the | Digital per GUI editor | 10 | mm/s |
| | nozzles spacing changes | | | |
| Zig-Zag Periods per | Number of times the | Digital per GUI editor | 0 | |
| 100 mm | nozzles oscillate per | | | |
| | 100 mm | | | |
| Primary Pump Speed | Rotation speed of Primary | Digital per GUI editor | 10 | rpm |
| | Pump | | | |
| Primary Pump Angle | Degrees of rotation of | Digital per GUI editor | 360 | deg |
| | Primary Pump per cycle | | | |
| Secondary Pump Speed | Rotation speed of | Digital per GUI editor | 400 | rpm |
| | Secondary Pump | | | |
| Suck-back Angle | Degrees of reverse | Digital per GUI editor | 90 | deg |
| | rotation of secondary | | | |
| | pump | | | |
| Sensor Pressure | Force threshold exerted | Digital per GUI editor | 25N | |
| | by tube pressure | | | |
| Nozzle Distance | Distance from nozzle tip | Manual | 6 | mm |
| | to the brick | | | |

| | | | |
|---|---|---|---|
| Nozzle Type | Type of nozzle being used | Manual | 1.6 mm ID Luer Lock |
| Adhesive Type | Adhesive being used | Manual | Suprasec 7372 |

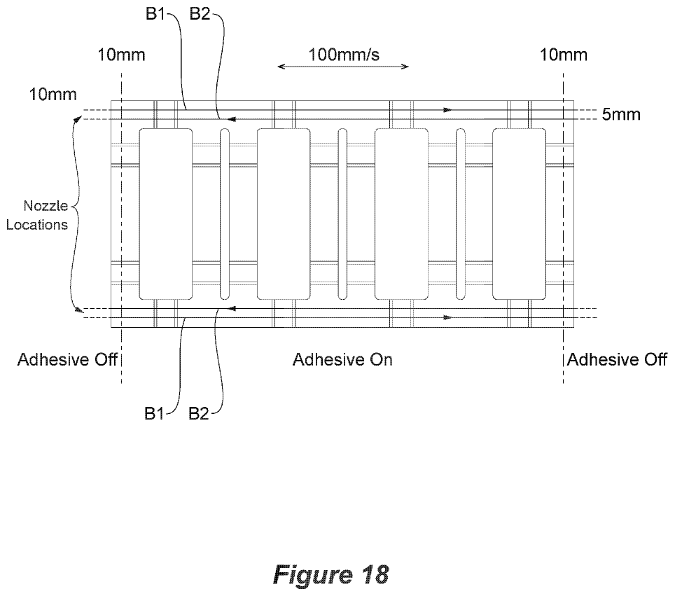

The dispense signature will define the placement of the adhesive onto each brick and will be determined by the brick data and dispense recipe variables. An example of a dispense signature is illustrated at FIG. 18. This dispense signature is for a wider (external) brick 160 of full length (i.e. not cut). Both nozzles 114, running simultaneously and in parallel, will run a first bead B1 of adhesive along a face of the brick 160 in a first direction, effect a lateral displacement, and then run a second bead B2 of adhesive along the face of the brick 160 in an opposite direction. As mentioned above, the dispense signature parameters illustrated in FIG. 18 will vary depending on the dispense recipe.

The dispense signature for a narrow (internal) brick will require the spacing between the nozzles 114 to be reduced. The dispense signature for a cut brick will require the beads to be shorter. The points at which the secondary pumps 116 switch on/off will vary depending on the dispense recipe, with the objective being to achieve even, continuous, identical beads that will form a good joint between the bricks in a wall.

In one example, the secondary pumps begin pumping before dispensing is required as it takes some time for the adhesive flow to reach the nozzles once the pumps are activated. The secondary pumps are then left running as adhesive begins to be dispensed along a dispense path. At a point part way along the dispense path and before a return point, the pumps are turned off so that excessive adhesive is not applied to the brick face. At the return point (when the brick begins moving in the opposite direction) the nozzles are translated slightly to begin dispensing along a parallel return path. The pumps are turned back on at the start of the return path before being turned off part away along the return path to begin slowing the rate of adhesive dispense before being turned on in reverse near the finish of the return path to operate in suck-back mode to prevent any dripping (i.e. suck drip back) or formation of large blobs near the end of the return path. The time when the secondary pumps are turned on/off or put in reverse will be determined by the dispense recipe being used which will be dependent on operating conditions and environmental factors as discussed.

In one example, approximately 4-5 mm of adhesive is applied per bead and the beads are dispensed so as to merge and puff up into a single bead via the capillary effect. In other examples, adhesive dispensed per bead may be in the range 3-4 mm, 4-5 mm, 5-6 mm, 6-7 mm, 7-8 mm, 8-9 mm and 9-10 mm. The width of a typical bead may be approximately 10 mm, although it could be anywhere in a range between 5-20 mm. In other arrangements, instead of dispensing a bead in a straight line, other patterns could be used such as zig-zag or sinusoidal having a defined amplitude etc.

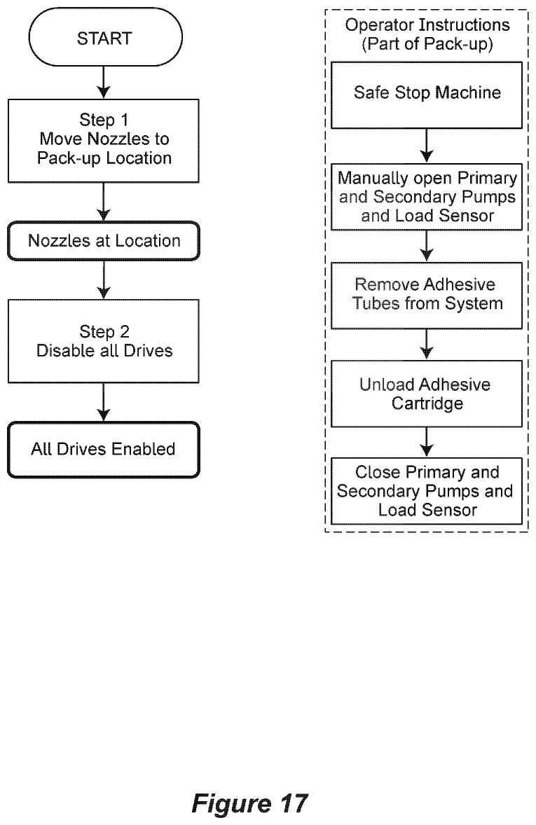

Referring now to FIG. 17, the stop sequence controls the stopping procedure for the adhesive application system 30. Upon activating the stop sequence, the adhesive application system 30 shall transition into a stopped state. The adhesive application system 30 shall command the nozzles 114 to move to their outermost positions (maximum software limit) for pack-up (Step 1). This position allows easier pack-up as it is the location of greatest extension.

Once the nozzles 114 are at the pack-up location, the system will disable all drives (Step 2). As with start-up, the adhesive cartridge 32 must be removed manually. The machine 1 must first be put into safe stop before approaching it. The adhesive line 34 tubes must be removed from the nozzles 114 and fed through the system in reverse. This involves opening the secondary pumps 116 and the pressure sensor 140 as per the start-up sequence. The adhesive cartridge 32 can then be removed from the machine 1 by the operator. This process is intended to be performed during machine pack-up.

The adhesive cartridge 32 and nozzle 114 supply tubes can then be disposed of according to safe operating procedure.

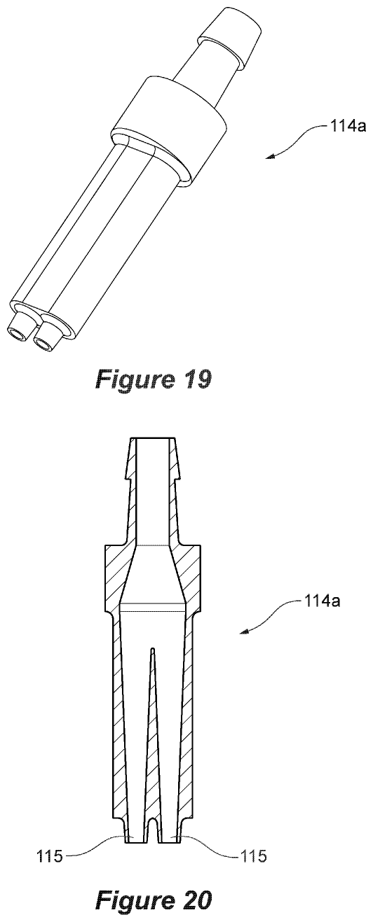

Referring now to FIGS. 19 and 20, where there is illustrated a nozzle 114a which can be used in place of nozzle 114 (typically having a luer-lock). Nozzle 114a comprises two outlets 115, where nozzle 114 only comprises one. This means that nozzle 114a could lay the two beads B1 and B2 of the supply signature of FIG. 18 with a single pass of the brick, whereas nozzle 114 would comprise two passes. Other nozzle arrangements could also be used such as a spray nozzle which would spray adhesive onto the brick instead of dispensing a line. Alternatively, nozzles with larger diameters could be used in order to increase volume that can be dispensed by each nozzle.

Advantageously, the present disclosure facilitates precise, controlled dispensing of adhesive to a brick, regardless of ambient conditions, or variations in brick width, length and any brick conversions, such as routs and cuts.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the invention.

1. An adhesive applicator assembly for an automated brick laying machine, the adhesive applicator assembly comprising a base, at least one nozzle carriage assembly, the or each nozzle carriage assembly comprising a carriage, and at least one adhesive outlet nozzle depending from the carriage, for dispensing adhesive received from a supply of adhesive via an adhesive supply line, and a transverse drive means for driving the or each nozzle carriage assembly transversely relative to the base.

2. The adhesive applicator assembly of claim 1, wherein the adhesive applicator assembly comprises at least two of the nozzle carriage assemblies.

3. The adhesive applicator assembly as in either of claim 1 or 2, wherein each of the nozzle carriage assemblies is movable independently of the others.

4. The adhesive applicator assembly as in any one of the preceding claims, wherein the base comprises a track, and the or each nozzle carriage assembly is disposed to run along the track.

5. The adhesive applicator assembly of claim 4, wherein the transverse drive means drives the or each nozzle carriage assembly along the track.

6. The adhesive applicator assembly as in any one of the preceding claims, wherein the or each nozzle carriage assembly comprises at least one adhesive pump delivering the adhesive to a respective nozzle.

7. The adhesive applicator assembly as in any one of claims 1 through 5, wherein the base comprises at least one adhesive pump delivering adhesive to each nozzle.

8. The adhesive applicator assembly as in any one of the preceding claims, wherein a position of each nozzle can be vertically adjusted with respect to the base.

9. The adhesive applicator assembly as in any one of the preceding claims, wherein a position of each nozzle can be vertically adjusted with respect to the carriage from which it depends.

10. The adhesive applicator assembly as in either of claim 8 or 9, wherein this vertical adjustment is manually effected.

11. The adhesive applicator assembly as in either of claim 8 or 9, wherein this vertical adjustment is automated.

12. The adhesive applicator assembly as in any one of the preceding claims, further comprising a supply line load cell sensing a supply pressure.

13. An adhesive application system for an automated brick laying machine, the adhesive application system comprising the adhesive applicator assembly as in any one of claims 1 through 12, an adhesive reservoir, the adhesive supply line extending from the reservoir to the or each nozzle, and at least one pump for delivering adhesive to the adhesive applicator assembly.

14. The adhesive application system of claim 13, further comprising a first pump (a primary pump) positioned near to the reservoir, further pumps (secondary pumps) positioned near to the or each of the nozzles, a supply line load cell positioned near to the further pumps, and a control system, wherein in use, the control system controls operation of the primary pump in response to a supply pressure sensed at the supply line load cell.

15. The adhesive application system of claim 14, wherein if a pressure sensed by the supply line load cell falls below a threshold pressure, the primary pump is controlled to return the sensed pressure to at least the threshold pressure.

16. The adhesive application system of either of claim 14 or 15, wherein the control system controls the secondary pumps based on an adhesive dispense recipe which comprises a set of variables used to control the dispensing of the adhesive, and a dispense signature which is determined by brick parameters and dispense recipe variables.

17. An adhesive application system for an automated brick laying machine, the adhesive application system comprising an adhesive reservoir, an adhesive supply line extending from the reservoir to one or more nozzles configured to dispense adhesive, a first pump (a primary pump) positioned near to the reservoir, at least one further pump (secondary pump) positioned near to the or each of the nozzles, a supply line load cell positioned near to the or each secondary pump, and a control system, wherein in use, the control system controls operation of the primary pump in response to a supply pressure sensed at the supply line load cell.

18. The adhesive application system of claim 17, wherein if a pressure sensed by the supply line load cell falls below a threshold pressure, the primary pump is controlled to return the sensed pressure to at least the threshold pressure.

19. The adhesive application system as in either of claim 17 or 18, wherein the control system controls the secondary pumps based on an adhesive dispense recipe which comprises a set of variables used to control the dispensing of the adhesive, and a dispense signature which is determined by brick parameters and dispense recipe variables.

20. The adhesive application system as in any one of claims 17 through 19, further comprising an adhesive applicator assembly comprising a base, at least one nozzle carriage assembly, the or each nozzle carriage assembly comprising a carriage and at least one of the nozzles depending from the carriage, and a transverse drive means for driving the or each nozzle carriage assembly transversely relative to the base.

21. The adhesive application system of claim 20, wherein the adhesive applicator assembly comprises at least two of the nozzle carriage assemblies.

22. The adhesive application system of claim 21, wherein each of the nozzle carriage assemblies is movable independently of the others.

23. The adhesive application system as in any one of claims 20 through 22, wherein the base of the adhesive applicator assembly comprises the supply line load cell.

24. A method for controlling an adhesive application system, the adhesive application system comprising an adhesive reservoir, an adhesive supply line extending from the reservoir to one or more nozzles configured to dispense adhesive, a first pump (a primary pump) positioned near to the reservoir, at least one further pump (secondary pump) positioned near to the nozzles, a supply line load cell positioned near to the or each secondary pump, and a control system, the method comprising the steps of monitoring the supply line load cell and controlling the operation of the primary pump in response to this.

25. The method of claim 24, wherein if a pressure sensed by the supply line load cell falls below a threshold pressure, the primary pump is controlled to return the sensed pressure to at least the threshold pressure.
